(19) United States
(12) Patent Application Publication
(10) Pub. No.: US 2016/0127619 A1
(43) Pub. Date: May 5, 2016

(54) VIDEO RECORDING KIT

(71) Applicant: McNaughton-McKay Electric Co., Madison Heights, MI (US)

(72) Inventors: James Witherspoon, Madison Heights, MI (US); Ryan Gribeck, Madison Heights, MI (US)

(21) Appl. No.: 14/932,462

(22) Filed: Nov. 4, 2015

Related U.S. Application Data
(60) Provisional application No. 62/074,969, filed on Nov. 4, 2014.

(51) Int. Cl. H04N 5/225; A45C 13/00; H04N 7/18; H04N 5/232; H04N 5/77; A45C 11/00; H04N 5/247

(52) U.S. Cl. CPC H04N 5/2252; A45C 11/00; A45C 13/005; H04N 5/247; H04N 5/23293; H04N 5/772; H04N 7/181; A45C 2011/003

(57) ABSTRACT

A portable remote video recording kit and method is described. The kit includes a portable carrying case containing a computer, a video screen, a switch, and a camera. The kit is designed to be used in a variety of fields including maintenance and troubleshooting of automated manufacturing activities, industrial engineering, quality control, production management, and safety. In use, the kit is positioned where monitoring is desired. The case is opened and the video screen is positioned for viewing. The camera is positioned near the monitoring site and connected wirelessly to the computer. The computer is programmed for continuous recording, motion-activated recording, and alarm-based recording of events.

### CROSS-REFERENCE TO RELATED APPLICATION

This application claims priority from U.S. Provisional Patent Application No. 62/074,969, filed Nov. 4, 2014, the disclosure of which is incorporated herein.

### FIELD OF THE INVENTION

This invention is directed to a kit for remote monitoring and recording of activities such as manufacturing activities. The kit can be used in fields such as maintenance and troubleshooting of automated manufacturing activities, industrial engineering, quality control, production management, and safety.

### BACKGROUND OF THE INVENTION

In automated manufacturing activities, video recording of the activities can be used to monitor for issues such as quality control problems, disruptions in processing, and improperly-aligned parts. Permanent video recording is expensive to install. Additionally, review of, for example, a video of an entire shift to find the time of a disruption is time-consuming. A need exists for a portable kit that can find root causes and precise times of occurrence of manufacturing problems.

### SUMMARY OF THE INVENTION

The preferred embodiment of the method of the present invention comprises a kit having a computer, a video screen, a switch, and at least one camera, all transported in a single case. One or more cameras can be set up to monitor and record a manufacturing process. A user can review the manufacturing process live or recorded from any location.

### BRIEF DESCRIPTION OF THE DRAWINGS

The organization and manner of the structure and operation of the invention, together with further objects and advantages thereof, may best be understood by reference to the following description, taken in connection with the accompanying non-scale drawings, wherein like reference numerals identify like elements in which:

FIG. 1 is a plan drawing of the components of the video recording kit of the preferred embodiment of the invention.

FIG. 2 is an orthographic projection of the components of the video recording kit of FIG. 1.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

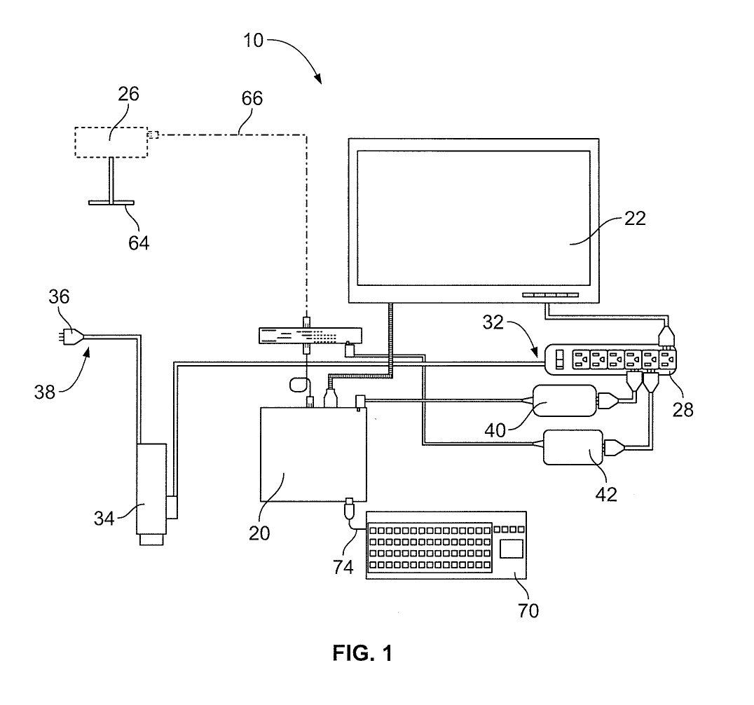

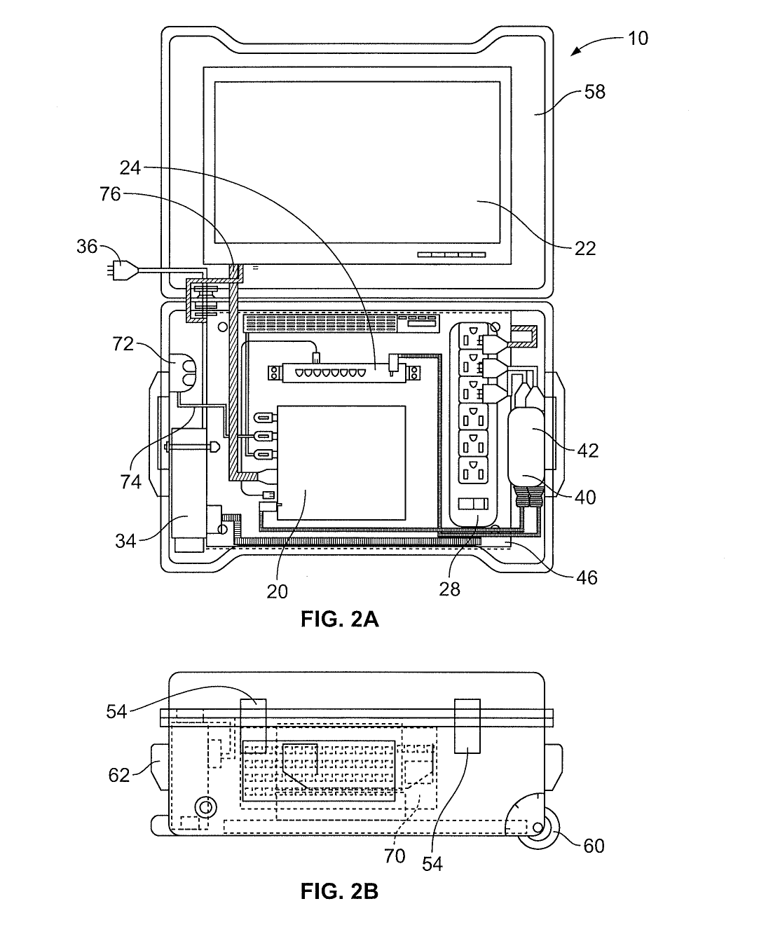

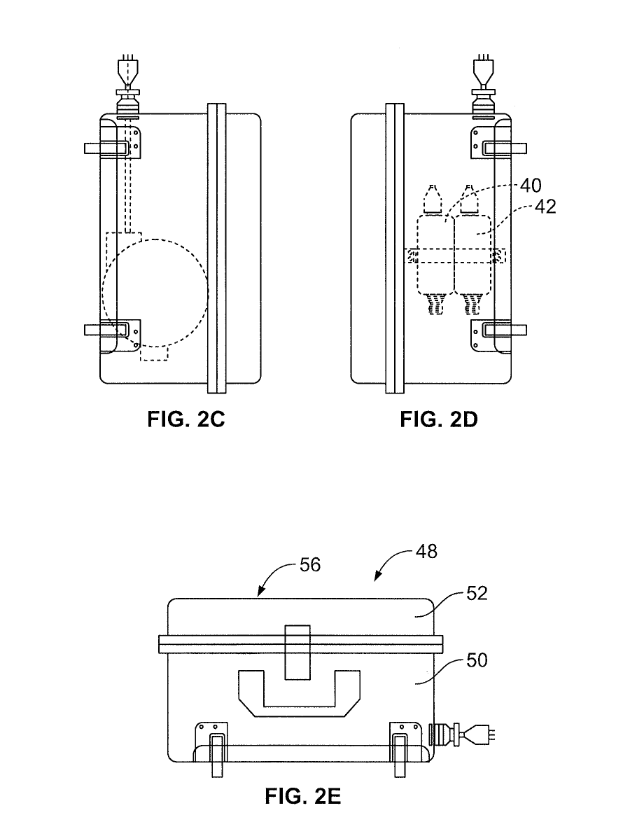

The preferred embodiment of the video recording kit 10 of the present invention is shown in plan view in FIG. 1 and in orthographic projection in FIG. 2. Kit 10 has a computer 20, a video screen 22, a switch 24, and a camera 26. In the preferred embodiment, kit 10 has a single camera 26 but is expandable to include multiple cameras. Computer 20 is preferably a computer having a small form factor and able to communicate wirelessly to a local area network or by cellphone, such as a Lenovo ThinkCentre M72e 4004H1U computer. Video screen 22 is preferably a color monitor such as a Lenovo LS1922 LED LCD monitor, model 2580AF1. Switch 24 is preferably an eight-port switch with four power-over-ethernet (POE) ports, such as a Trendnet TPE-S44 (version A2.2R). Camera 26 is preferably a true HD color camera having five megapixels of resolution and a frame rate of 60 fps and the ability to pan/tilt/zoom, and the ability to record non-visual images such as thermal images and infrared images.

A power strip 28 is connected to a first end 30 of a power cable 32, which winds on a reel 34. A male power plug 36 is connected to a second end 38 of power cable 32. Computer 20 is coupled to an adapter 40 which plugs into power strip 28. Switch 24 is coupled to an adapter 42 which plugs into power strip 28.

Computer 20, switch 24, and power strip 28 are mounted on a subpanel 46. Subpanel 46 is preferably a 12-gauge steel panel finished with powder paint or another corrosion-resistant coating, and is preferably a panel such as is offered under product code HOFA20P16 by Hoffman, a division of Pentair Technical Products.

Subpanel 46 and reel 34 are mounted inside a roller case 48. Case 48 is preferably a box-shaped structure with a main body 50 and a lid 52. Preferably, lid 52 is connected to body 50 by a hinge 54 and has top side 56 and a bottom side 58. Video screen 22 is mounted to bottom side 58 and has a power cord 76 that plugs into power strip 28.

Hinge 54 is preferably a friction hinge, so that lid 52 can open and stay in an almost upright position, preferably 115 degrees from body 50. Alternatively, hinge 54 may be a detent hinge, with multiple soft stops to hold lid 52 at different angles from body 50, such as at 90, 100, and 110 degrees.

Case 48 preferably has at least one, preferably two, and alternatively three or more rollers or wheels 60 mounted on body 50 opposite lid 52. Additionally, a handle 62 is attached to body 50 to pull case 48 on wheels 60. Handle 62 can be hinged or telescoping.

Camera 26 is preferably removably attached to an adjustable camera mount 64. Mount 64 is preferably a C-clamp with telescoping or articulating arms and a swivel head so camera 26 can be mounted to any convenient structure and aligned in the proper direction. Camera 26 preferably has a single Ethernet cable 66 for power and communication. Cable 66 plugs into switch 24 when in use. Alternatively, camera 26 can have separate power and communication cables that plug into power strip 28 and switch 24, respectively. Further still, camera 26 can have an on-board power source such as a battery and connect to switch 24 by a wireless technology standard, such as Bluetooth or IEEE 802.11. When camera 26 is not in use, camera 26 and cable 66 are stored in case 48.

A keyboard 70 and a mouse 72, both of which are conventional computer accessories known in the art, are coupled to computer 20 by standard cables 74. Keyboard 70 and mouse 72 can also communicate with computer 20 by any wireless standard appropriate for conventional computer accessories. Keyboard 70 and mouse 72 and their cables, if present, are stored in case 48 when not in use. Alternatively, video screen 22 can be a touch screen so that a keyboard and mouse are not necessary.

Camera 26 is preferably configured to provide continuous recording, motion-based recording, and pre-event recording. Motion-based recording can be accomplished by using PLC alarms or OPC alarms. Pre-event recording can be configured to record events leading to an alarm event, the alarm event itself, and events after the alarm.

In use, kit 10 is rolled to the site where monitoring is desired. Case 48 is opened and lid 52 is placed at a convenient angle for viewing by the user. Power cable 32 is pulled out of reel 34 and plug 36 is plugged into the nearest outlet. Camera mount 64 is attached to a steady structure nearby the monitoring site and Ethernet cable 66 is plugged into switch 24. Keyboard 70 and mouse 72 are removed from case 48 and computer 20 is powered on. An internet connection is located, preferably wirelessly but alternatively by use of an additional Ethernet cable.

Computer 20 is programmed for three techniques to record events: Continuous recording, motion-activated recording, and alarm-based recording. Computer 20 is preferably programmed with video analytics and business intelligence software, preferably intelligent video surveillance software such as is sold by Aimetis Corp. under the name Symphony™. The video analytics software preferably is able to record events using all three techniques and preferably has the following features:

Real-time alerting, to direct the attention of monitoring personnel to relevant activity in real-time.

Intelligent search, to allow users to pinpoint specific events and to select specific search parameters, such as time, activity, and location.

Reporting, to allow users to display video data with reports, charts, and graphs.

For continuous recording, camera 26 is aligned at an area of interest and records that area continuously. A remote user who wishes to check on that area of interest can log onto computer 20 through an Internet browser and watch video in real time. This technique is useful in, for example, security systems.

For motion-based recording, computer 20 is programmed to activate camera 26 only upon detection of motion. A remote user who wishes to check on whether there has been any motion in the area of interest can log onto computer 20 through an Internet browser and watch video of motion-activated events. This technique is useful in, for example, theft prevention. Camera 26 is aligned with items of interest, such as a storage area for valuable raw materials or parts. Video is recorded only when motion is detected, such as by a person removing one or more items from the storage area. A remote user can check to see that all persons removing items are authorized to do so.

For alarm-based recording, computer 20 is programmed to record video only upon occurrence of a pre-selected alarm. A remote user who wishes to view video of an alarm event can log onto computer 20 through an Internet browser and watch video of alarm-activated videos. For example, a robot-based manufacturing system can be the subject of alarm-based recording. An 10 module is coupled to some aspect of the robot's activity and is connected by an Ethernet cable to switch 24. Upon detection of a pre-selected event, such as improper alignment of parts delivered to the robot, computer 20 records the event along with a pre-selected interval before and after the event.

To same pre-event video, camera 26 records the area of interest continuously. Video is saved to volatile RAM in computer 20. Only a pre-selected time segment is saved, such as three minutes in the case of recording of a robot-based manufacturing system. Video in RAM from over three minutes past is discarded as newer video is saved in RAM. Upon occurrence of the pre-selected event, however, all the past video in RAM is saved to the non-volatile memory of computer 20, along with video of the event and video for the following pre-selected time period, such as three minutes. Accordingly, in the example given, occurrence of the event causes computer 20 to record three minutes before and three minutes after occurrence of the event. A remote user can log onto computer 20 to view this video.

An alarm can be set up using, for example, a discrete 10 module such as a Modbus TCP module sold under the name ADAM-6050 by Advantech Co., Ltd. Alternatively, an OPC alarm can be used.

Alternatively, an alarm can be set up using direct PLC communication such as Profinet or Ethernet/IP. While preferred embodiments of the present invention are shown and described, it is envisioned that those skilled in the art may devise various modifications of the present invention without departing from the spirit and scope of the appended claims.

We claim:

1. A video recording kit comprising:
a case comprising a main body, an interior, a lid, and at least one hinge connecting the main body with the lid;
a computer mounted in the interior of the case;
a video screen mounted to a bottom side of said lid and connected with said computer;
a switch mounted in the interior of the case connected with said computer; and
one or more cameras connected with said computer.
